(19) United States
(12) Patent Application Publication
(10) Pub. No.: US 2003/0141432 A1
(43) Pub. Date: Jul. 31, 2003

(54) Collapsible corner assembly for use in a form assembly

(76) Inventor: Dennis E. Carr, Atkinson, NH (US)

Correspondence Address: BOURQUE & ASSOCIATES, P.A., Suite 301, 835 Hanover Street, Manchester, NH, 03104, US

(21) Appl. No.: 10/061,795

(22) Filed: Jan. 31, 2002

(51) Int. Cl. B28B 7/30

(52) U.S. Cl. 249/194; 249/152; 249/184

(57) ABSTRACT

A collapsible corner assembly is used in a collapsible form assembly to form a hollow structure, such as a four or five sided hollow concrete structure. One embodiment of the form assembly includes two collapsible corner assemblies, two fixed corner assemblies, and intermediate panels coupled to the corner assemblies. Each collapsible corner assembly preferably includes collapsible side portions and retractable members forming outer corner forming surfaces. To collapse the collapsible corner assembly, the retractable members are retracted and the collapsible side portions are moved inwardly. Collapsing the collapsible corner assemblies allows the form assembly to be removed from the hollow structure.

### TECHNICAL FIELD

The present invention relates to form assemblies for use in casting concrete and more particularly, to a collapsible corner assembly for use in the corner of the form assembly to form the corners of a concrete cast wall structure.

### BACKGROUND INFORMATION

Form assemblies are well known for use in casting hollow concrete structures such as concrete elevator shafts and stairwells in building construction. These hollow concrete structures typically have at least four side walls but can have other shapes as well. The form assemblies typically include an outer form to form the outside of the concrete walls and an inner form to form the inside of the concrete walls. The concrete is poured between the inner and outer forms, and after the concrete cures, the forms are removed. Inner forms have been designed to be collapsible to allow the inner forms to be removed from within the hollow structure after the concrete has hardened. Although various types of collapsible inner forms have been used, some collapsible forms are vulnerable to concrete resulting in a failure of the form to collapse.

Accordingly, there is a need for a collapsible form structure, and specifically a collapsible corner assembly, that is versatile, relatively easy to use, and less vulnerable to concrete and thus is less likely to fail.

### SUMMARY

In accordance with one aspect of the present invention, a collapsible corner assembly is provided for use with a form assembly for forming a structure from a moldable material. The collapsible corner assembly comprises a main body including a main body forming surface. First and second collapsible side portions are operatively coupled to the main body. Each of the collapsible side portions has a collapsible forming surface aligned with the main body forming surface. First and second retractable members are operatively coupled to the main body. Each of the retractable members has a retractable forming surface. When the collapsible corner assembly is in an uncollapsed position, the main body forming surface, the collapsible forming surfaces, and the retractable forming surfaces all form an outer corner forming surface. When the collapsing mechanism is in a collapsed position, the retractable forming surfaces retract and the main body forming surface and the collapsible forming surfaces form the outer corner forming surface.

In one embodiment, a collapsing mechanism housed within the main body is used to retract the retractable members and to move the collapsible side portions inwardly. One embodiment of the collapsing mechanism includes at least first and second cams engaging respective first and second retractable members for retracting the retractable members. At least first and second threaded rods are coupled to respective first and second collapsible side portions for pulling each of the collapsible side portions inwardly to the collapsed position. The collapsing mechanism further includes at least first and second threaded sprocket nuts receiving respective first and second threaded rods and at least first and second link bars coupled to respective first and second cams for rotating the cams. At least first and second chains are engaged with respective first and second threaded sprocket nuts for rotating the threaded sprocket nuts and drawing the threaded rods inwardly. At least one hydraulic cylinder is coupled to the first and second link bars and to the first and second chains for moving the link bars and the chains.

According to another aspect of the present invention, a collapsible form assembly is provided for use in forming a structure from a moldable material. The collapsible form assembly comprises at least first and second collapsible corner assemblies for positioning at opposite corners. Each of the collapsible corner assemblies includes collapsible side portions and retractable members forming outer corner forming surfaces. The retractable members retract and the collapsible side portions collapse inwardly to shrink the outer corner forming surfaces. The collapsible form assembly also comprises at least first and second fixed corner assemblies for positioning at opposite corners. Intermediate panels are adapted to be secured between the collapsible corner assemblies and respective fixed corner assemblies.

### BRIEF DESCRIPTION OF THE DRAWINGS

These and other features and advantages of the present invention will be better understood by reading the following detailed description, taken together with the drawings wherein:

FIG. 1 is a top plan view of a collapsible form assembly used to form a hollow structure, according to one embodiment of the present invention;

FIG. 2 is a top plan view of one embodiment of a collapsible corner assembly in an uncollapsed position;

FIG. 3 is a top plan view of one embodiment of a collapsible corner assembly in a collapsed position;

FIG. 4 is an isometric view of an outside corner surface of one embodiment of the collapsible corner assembly;

FIG. 5 is an isometric view of an inside portion of one embodiment of a fixed corner assembly;

FIG. 6 is an isometric view of the inside of one embodiment of the collapsible corner assembly in an uncollapsed position;

FIG. 7 is an isometric view of the inside portion of one embodiment of the collapsible corner assembly in a collapsed position;

FIG. 8 is an isometric view of a portion of one embodiment of the collapsing mechanism;

FIG. 9 is an isometric view of another portion of one embodiment of the collapsing mechanism;

FIG. 10 is a side view of one embodiment of a head assembly used in the collapsing mechanism shown in FIGS. 8 and 9;

FIG. 11 is a side view of one embodiment of a link bar used in the collapsing mechanism shown in FIG. 9;

FIG. 12 is an isometric view of one embodiment of a cam used in the collapsing mechanism shown in FIG. 9;

FIG. 13 is an isometric view of one embodiment of a main body portion of the collapsible corner assembly; and

FIG. 14 is a front view of one embodiment of a cover of the collapsible corner assembly.

### DETAILED DESCRIPTION OF THE PREFERRED EMBODIMENTS

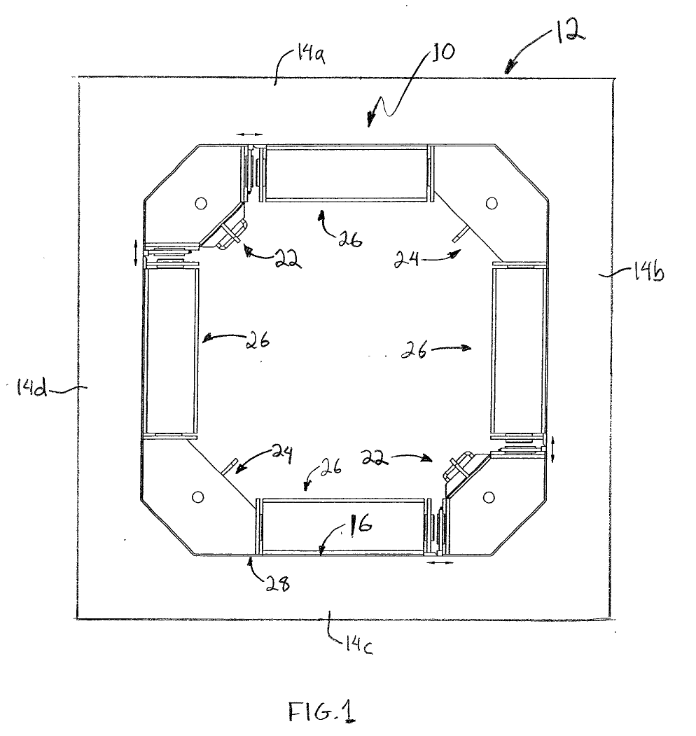

Referring to FIG. 1, a collapsible form assembly 10 is used to form a hollow structure 12 from a moldable material such as concrete. The exemplary embodiment of the hollow structure 12 has four walls 14a-d. The collapsible form assembly 10 can be used to form hollow structures having other shapes and from other types of moldable materials. The collapsible form assembly 10 is positioned on the inside of the hollow structure 12 to form the inner surface 16 of the walls 14a-d. An outer form assembly (not shown), such as the type known to those of ordinary skill in the art, is positioned on the outside of the hollow structure 12 to form the outside surface.

The collapsible form assembly 10 includes collapsible corner assemblies 22, fixed corner assemblies 24, and intermediate panels 26 secured between the collapsible corner assemblies 22 and the fixed corner assemblies 24. The collapsible form assembly 10 provides an outer forming surface 28 that forms the inner surface 16 of the wall structure 12. The inner surface 16 is preferably formed as a substantially smooth surface. When the collapsible corner assemblies 22 collapse, the entire form assembly 10 shrinks on each side to allow the form assembly 10 to be removed from the hollow structure 12.

In the exemplary embodiment, each side of the form assembly 10 shrinks about ¾ in. A collapsible corner assembly 22 having a width of about 18″ collapses to a width of about 17 ¼ inches. Other dimensions are also contemplated. Also, by varying the size of the intermediate panels 26, the form assembly 10 can be used to form hollow concrete structures 12 having a wide range of dimensions. According to another embodiment of the form assembly 10, the corner assemblies 22, 24 can be connected directly without any intermediate panels 26. According to a further embodiment of the form assembly 10, the collapsible corner assemblies 22 can be permanently incorporated into a collapsible form assembly 10 (i.e., without being a stand alone component).

In another embodiment, a top plate (not shown) can be positioned over the form assembly 10. This embodiment is used to form a monolithic 5-sided structure (not shown). The fifth wall of the structure is formed by pouring concrete over the top plate. When the collapsible form assembly 10 is collapsed, the 5-sided structure is lifted upwards and removed from the form assembly 10.

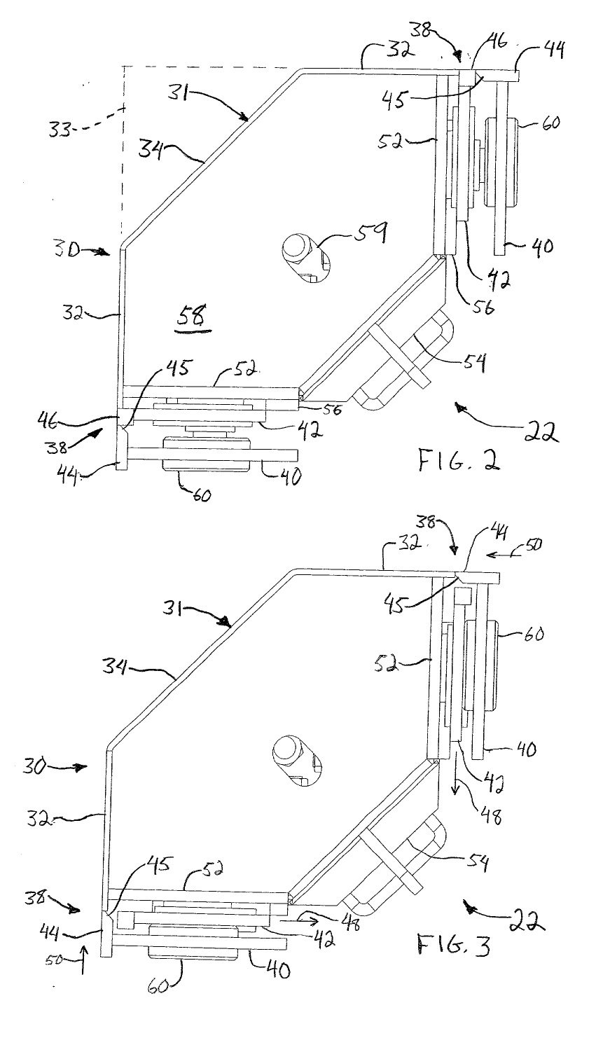

Referring to FIGS. 2 and 3, the exemplary embodiment of the collapsible corner assembly 22 is described in greater detail below. The collapsible corner assembly 22 includes a main body 30 having a main body forming surface 31, for example, formed by at least two main body side panels 32. The exemplary embodiment of the main body 30 also includes a center panel 34 such that the main body forming surface 31 is shaped to form flat corner surfaces within the wall structure 12. In one embodiment, a corner adapter (not shown) can be secured to the center panel 34 to form a square corner 33 or other corner of a different shape. Alternatively, the main body 30 can include a main body forming surface formed by two side panels 32, which form the square corner 33. Other shapes of the main body forming surface are also contemplated.

The collapsible corner assembly 22 also includes collapsible side portions 40 and retractable members 42 positioned between the body portion 30 and the collapsible side portions 40. The collapsible side portions 40 have collapsible forming surfaces 44 generally aligned with the main body forming surface 31, e.g., respective main body side panels 32. The retractable members 42 have retractable forming surfaces 46. The collapsible side portions 40 preferably have a taper 45 to provide clearance for the retractable members 42 when the collapsible corner assembly 22 is being collapsed, as described below. Although one embodiment is shown and described herein, the collapsible side portions 40 and retractable members 42 can have other shapes and configurations.

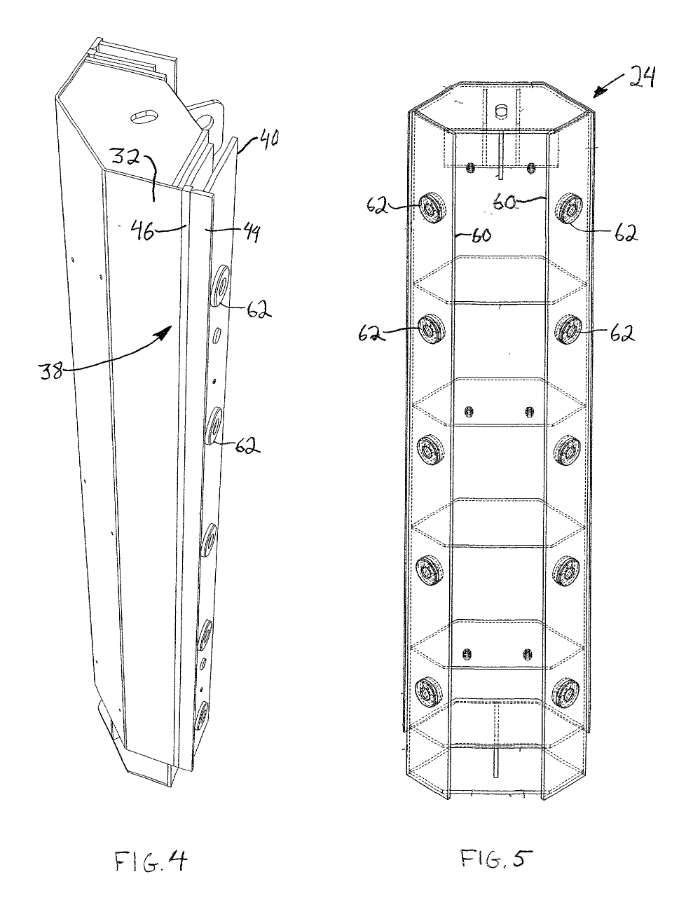

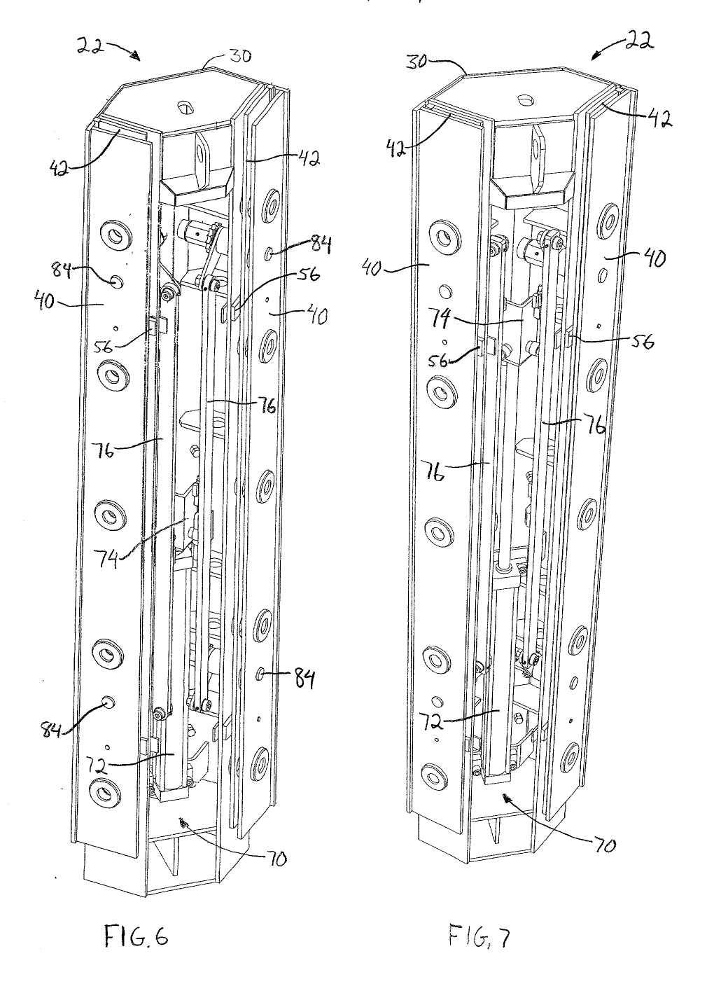

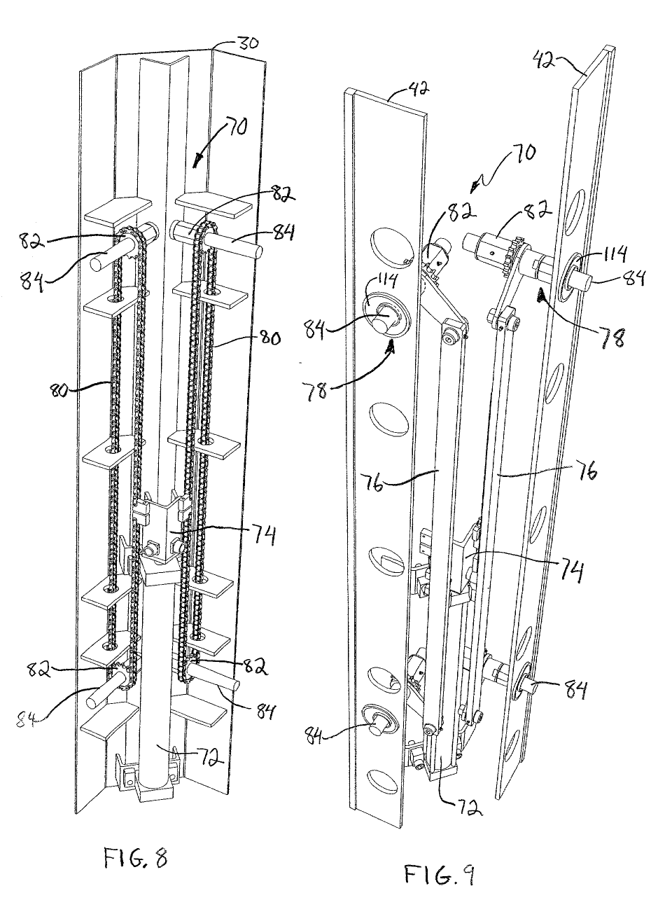

In the uncollapsed position (FIG. 2), the respective main body forming surface 31, retractable forming surfaces 46, and collapsible forming surfaces 44 form an outer corner forming surface 38 on the collapsible corner assembly 22. The outer corner surface 38 formed by the main body forming surface 31, retractable forming surface 46 and collapsible forming surface 44 is shown in FIG. 4. When the collapsible corner assembly 22 collapses (FIG. 3), the retractable members 42 retract generally in the direction of arrows 48 and the collapsible side members 40 move inwardly generally in the direction of arrows 50. In the collapsed position (FIG. 3), the main body forming surface 31 and the collapsible forming surfaces 44 form the outer corner forming surfaces 38. This design of the collapsible corner assembly 22 is less vulnerable to the concrete and the collapsible side portions 40 are less susceptible to binding when they move inwardly.

The exemplary embodiment of the main body 30 also includes fixed side portions 52. A cover 54 covers the inside of the collapsible corner assembly 22. In the exemplary embodiment, the retractable members 42 are sandwiched between the collapsible side portions 40 and the fixed side portions 52. At least one compression spring (not shown) can be positioned between the collapsible side portions 40 and the retractable member 42 to ensure that the retractable members 42 to ride on bars 56 attached to the fixed side portions 52.

The main body 30 also includes a top panel 58. The top panel 58 preferably includes an alignment hole 59 for receiving an alignment member or stud extending from the top plate (not shown) when used to form a 5-sided structure. The alignment hole 59 is dimensioned to align or center the top plate over the form assembly 10 while allowing the collapsible form assembly 10 to shrink and slide relative to the top plate. The hole 59 can have an oblong shape (as shown in FIGS. 2 and 3) or a round shape (as shown in FIG. 1).

Referring to FIG. 5, one embodiment of the fixed corner assembly 24 is shown in greater detail. The fixed corner assembly 24 provides generally the same corner shape as the collapsible corner assembly 22. The fixed corner assembly 24 includes fixed side portions 60. Both the fixed side portions 60 and the collapsible side portions 40 are secured to the intermediate panels 26. In the exemplary embodiment, the fixed side portions 60 and the collapsible side portions 40 are boss plates having bosses 62 for bolting to the intermediate panels 26 using techniques known to those of ordinary skill in the art.

Referring to FIGS. 6 and 7, a collapsing mechanism 70 is housed within the main body 30 of the collapsible corner assembly 22. The collapsing mechanism 70 is coupled to the collapsible side portions 40 and to the retractable members 42. The collapsing mechanism 70 causes the retractable members 42 to retract and causes the collapsible side portions 40 to move inwardly, as will be described in greater detail below.

Referring also to FIGS. 8 and 9, the exemplary embodiment of the collapsing mechanism 70 is described in greater detail. The collapsing mechanism 70 includes a hydraulic cylinder 72 driving a head assembly 74. The head assembly 74 engages link bars 76. The link bars 76 are coupled to cams 78, which engage races in the retractable members 42 for moving the retractable members 42. The other holes in the retractable members 42 allow access to the fasteners securing the collapsible corner 22 to the adjacent intermediate panels 26. Chains 80 are coupled to the head assembly 74 and engage threaded sprocket nuts 82. The sprocket nuts 82 receive threaded rods 84, which are attached to the collapsible side portions 40 (e.g., by welding) for moving the collapsible side portions 40 inwardly (see FIGS. 6 and 7).

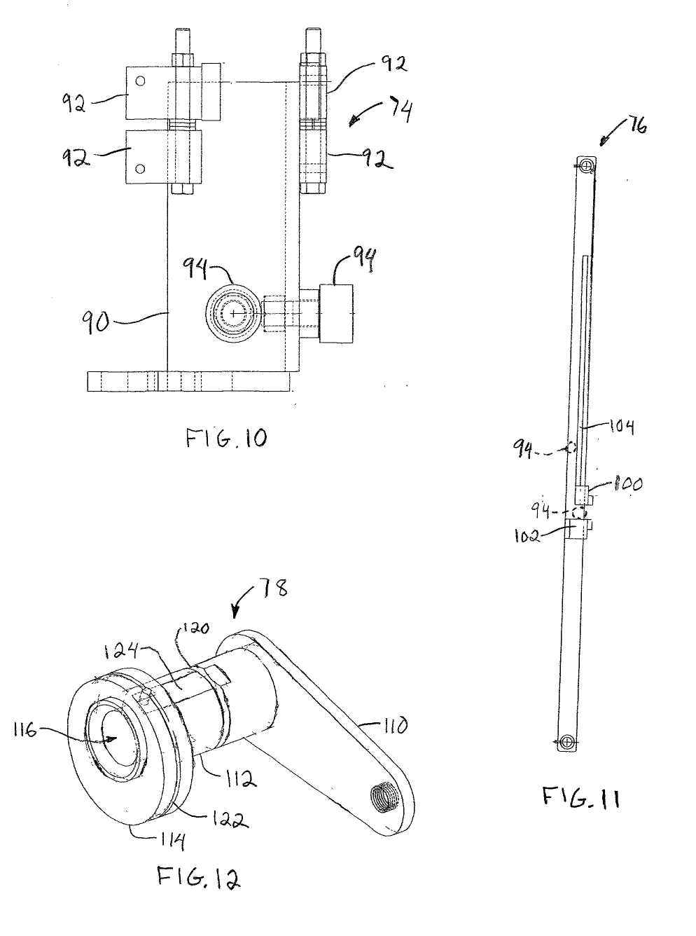

Referring to FIG. 10, the exemplary embodiment of the head assembly 74 is described in greater detail below. The head assembly 74 includes a body portion 90 capable of being secured to the hydraulic cylinder 70. Link connectors 92 are coupled to the head body portion 90 for connecting to ends of the respective chains 80. Cam followers 94 are also coupled to the head body portion 90 for engaging with the respective link bars 76. Other shapes and configurations for the head assembly 74 are also contemplated.

Referring to FIG. 11, the exemplary embodiment of the link bar 76 is described in greater detail below. The link bar 76 includes guide members 100, 102 for engaging and guiding the respective cam follower 94 on the head assembly 74 at the beginning of the stroke of the hydraulic cylinder 72. The link bar 76 also includes a track guide member 104 for guiding the cam follower 94 at the end of the stroke, as will be described in greater detail below. The link bar 76 is coupled to a cam 78 at each end of the link bar 76.

Referring to FIG. 12, the exemplary embodiment of the cam 78 is described in greater detail below. The cam 78 includes an arm 110 for coupling to the link bar 76. A hollow shaft 112 extends from the arm 110 to an eccentric cam member 114 at the opposite end. The eccentric cam member 114 engages a race formed in one of the retractable members 42 (see FIG. 9). The hollow shaft 112 includes a hole 116 for receiving one of the threaded rods 84 (see FIG. 9). A grease track 120 is formed around the hollow shaft 112 and a grease track 122 is formed around the eccentric cam 114. The grease tracks 120, 122 can be connected by a channel 124 such that grease applied through a single grease fitting to one of the tracks 120, 122 flows to the other track.

Referring to FIG. 13, the exemplary embodiment of the main body 30 is described in greater detail below. Tubes 130 attached to the fixed side portions 52 of the main body receive and support the hollow shaft 112 of the cam 178. These tubes 130 can include the grease fitting for injecting grease to the tracks 120, 122. Tubes 132 mounted inside the main body 30 receive the threaded rods 84.

Braces 134 inside of the main body 30 are used for mounting the hydraulic cylinder 72. A stabilizing bar 136 is mounted within the main body 130 to prevent the hydraulic cylinder rode from being pulled off center. The center panel 34 of the main body 30 includes holes 138 for coupling the main body 30 to a corner adapter. When a corner adapter is not used, plug bolts can be threaded into the holes 138 to plug them.

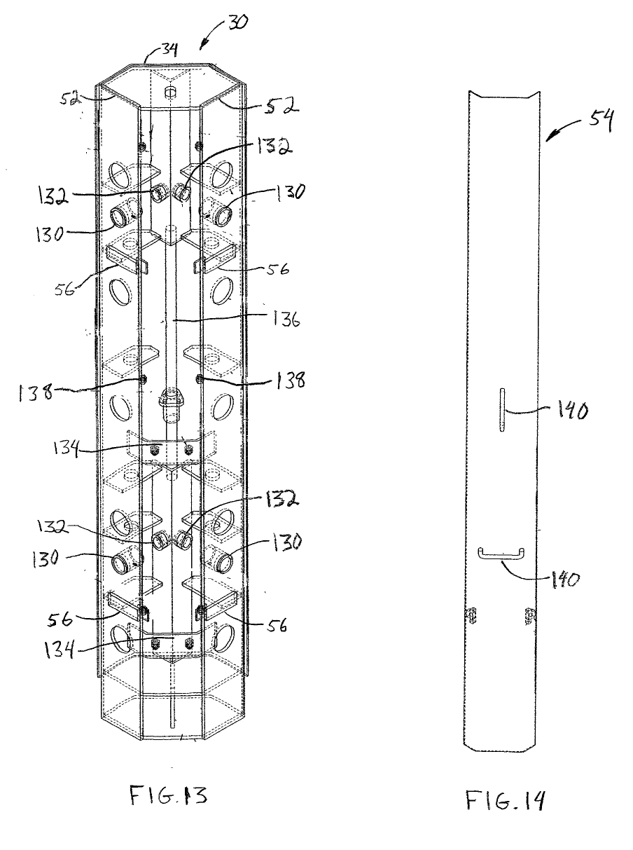

The cover 54 is shown in greater detail in FIG. 14. Handles 140 can be attached to the cover 54 to allow the cover 54 to be removed, for example, to access the collapsing mechanism 70 inside the main body 30 of the collapsible corner assembly 22.

During operation of the collapsing mechanism 70 to collapse the collapsible corner assembly 22, the hydraulic cylinder 72 moves the head assembly 74 in an upward direction (see FIG. 7). In the exemplary embodiment, the stroke is about 30 in. When the head assembly 74 starts its upward motion, the cam follower 94 applies force against the guide members 100 to force the link bars 76 upward. Moving the link bars 76 upward moves the arms 110 of the cams 78, causing the eccentric cam members 114 to rotate. The rotation of the eccentric cam members 114 causes the retractable members 42 engaging the eccentric cam members 114 to retract. The head assembly 74 also moves the chains 80, which rotate the sprocket nuts 82. The rotating sprocket nuts 82 engage the threads on the threaded rods 84 to draw the threaded rods 84 inwardly and thus move the collapsible side portions 40 inwardly.

The collapsing mechanism 70 is preferably designed to retract the retractable members 42 more quickly than moving the collapsible side portions 40. This is accomplished in the exemplary embodiment by having the head assembly 74 move the link bars 76 at the beginning of the stroke and then move independently of the link bars 76 at the end of the stroke. As shown in FIG. 11, part way through the stroke, the cam follower 94 moves out of engagement with the guide members 100, 102 and slides upward on the guide track 104 such that the head assembly 74 no longer moves the link bar 76. In one example, a 30″ stroke of the hydraulic cylinder 73 causes the collapsible side portions 40 to move about ¾ in., and the first 10″ of the stroke moves the link bar 76 a sufficient distance to retract the retractable member 42.

Accordingly, the collapsible corner assembly described herein can be used in a collapsible form assembly to form a wall structure. The collapsible corner assembly is versatile, relatively easy to use, and is less susceptible to binding when the form assembly is collapsed.

Although an exemplary embodiment of the collapsing mechanism 70 is shown and described, variations of the collapsing mechanism 70 are within the scope of the present invention. Any mechanism capable of retracting the retractable member 42 and collapsing the collapsible side portions 40 can be used in the present invention. Also, the present invention is not limited by the specific shapes and dimensions of the components shown herein.

Modifications and substitutions by one of ordinary skill in the art are considered to be within the scope of the present invention, which is not to be limited except by the following claims.

The invention claimed is:

1. A collapsible corner assembly for use with a form assembly for forming a structure from a moldable material, said collapsible corner assembly comprising:
a main body including a forming surface;
first and second collapsible side portions operatively coupled to said main body, each of said collapsible side portions having collapsible forming surfaces aligned with said main body forming surface; and
first and second retractable members operatively coupled to said main body, each of said retractable members having retractable forming surfaces, wherein said main body forming surface, said collapsible forming surfaces, and said retractable forming surfaces form outer corner forming surfaces when said collapsible corner assembly is in an uncollapsed position, and wherein said retractable forming surfaces retract and said main body forming surface and said collapsible forming surfaces form said outer corner forming surfaces when said collapsible corner assembly is in a collapsed position.

2. The collapsible corner assembly of claim 1 wherein said main body forming surface is formed by main body side panels and a center panel between said main body side panels.

3. The collapsible corner assembly of claim 1 further including a collapsing mechanism located within said main body for retracting said retractable members and for moving said collapsible side portions inwardly.

4. The collapsible corner assembly of claim 3 wherein said collapsing mechanism includes:
at least first and second cams engaging respective said first and second retractable members for retracting said retractable members; and
at least first and second threaded rods coupled to respective said first and second collapsible side portions for pulling each of said collapsible side portions inwardly to said collapsed position.

5. The collapsible corner assembly of claim 4 wherein said collapsing mechanism further includes:
at least first and second threaded sprocket nuts receiving respective said first and second threaded rods;
at least first and second link bars coupled to respective said first and second cams for rotating said cams; and
at least first and second chains engaged with respective said first and second threaded sprocket nuts for rotating said threaded sprocket nuts and drawing said threaded rods inward.

6. The collapsible corner assembly of claim 5 wherein said collapsing mechanism further includes at least one hydraulic cylinder coupled to said first and second link bars and to said first and second chains for moving said link bars and said chains.

7. The collapsible corner assembly of claim 1 wherein said collapsible side portions have a tapered edge to provide clearance from said retractable members.

8. The collapsible corner assembly of claim 1 wherein said main body portion includes fixed side plates, wherein said collapsible side portions include collapsible side plates, and wherein said retractable members include retractable plates between said fixed side plates and said collapsible side plates.

9. The collapsible corner assembly of claim 1 further including a cover member for covering a section of said main body portion.

10. The collapsible corner assembly of claim 2 further including a corner adapted to be positioned against said center panel.

11. The collapsible corner assembly of claim 1 further comprising means for retracting said retractable members and for moving said collapsible portions inwardly.

12. A collapsible corner assembly for use with a form assembly for forming a structure from a moldable material, said collapsible corner assembly providing outer corner surfaces to form a corner of said structure, said collapsible corner assembly comprising:
a main body including a main body forming surface;
a collapsing mechanism housed within said main body;
first and second collapsible side portions coupled to said collapsing mechanism, each of said collapsible side portions having collapsible forming surfaces aligned with said main body forming surface; and
first and second retractable members coupled to said collapsing mechanism, each of said retractable members having retractable forming surfaces, wherein said main body forming surface, said collapsible forming surfaces, and said retractable forming surfaces form said outer corner forming surfaces when said collapsing mechanism is in an uncollapsed position, and wherein said retractable forming surfaces retract and said main body forming surface and said collapsible forming surfaces form said outer corner forming surfaces when said collapsing mechanism is in a collapsed position.

13. A collapsible form assembly for use in forming a structure from a moldable material, said collapsible form assembly comprising:
at least first and second collapsible corner assemblies for positioning at opposite corners, wherein each of said collapsible corner assemblies include collapsible side portions and retractable members forming outer corner forming surfaces, and wherein said retractable members retract and said collapsible side portions move inwardly to shrink said outer corner forming surfaces; and
at least first and second fixed corner assemblies for positioning at opposite corners, wherein said fixed corner assemblies are adapted to be coupled to said collapsible corner assemblies.

14. The collapsible form assembly of claim 13 further comprising:
intermediate panels adapted to be secured between said collapsible corner assemblies and respective said fixed corner assemblies.

15. The collapsible form assembly of claim 13 further including a top plate for positioning above said collapsible corner assemblies and said fixed corner assemblies.

16. The collapsible form assembly of claim 13 wherein each of said collapsible corner assemblies includes a main body including a forming surface, wherein each of said collapsible side portions have collapsible forming surfaces aligned with said main body forming surface, and wherein each of said retractable members have retractable forming surfaces; and
wherein said main body forming surface, said collapsible forming surfaces, and said retractable forming surfaces form said outer corner forming surfaces when said collapsible corner assembly is in an uncollapsed position, and wherein said retractable forming surfaces retract and said main body forming surface and said collapsible forming surfaces form said outer corner forming surfaces when said collapsible corner assembly is in a collapsed position.

17. The collapsible form assembly of claim 13 wherein each of said collapsible corner assemblies further includes a collapsing mechanism housed within said main body and coupled to said collapsible side portions and to said retractable members.

18. The collapsible form assembly of claim 17 wherein said collapsing mechanism includes:
cams engaging respective said retractable members for retracting said retractable members; and
threaded rods coupled to respective said collapsible side portions for pulling each of said collapsible side portions inwardly to said collapsed position.

19. The collapsible form assembly of claim 18 wherein said collapsing mechanism further includes:
threaded sprocket nuts receiving respective said threaded rods;
link bars coupled to respective said cams for rotating said cams; and
chains engaged with respective said threaded sprocket nuts for rotating said threaded sprocket nuts and drawing said threaded rods inward.

20. The collapsible form assembly of claim 13 wherein each of said collapsible corner assemblies further includes a means for collapsing said collapsible corner assembly.

21. The collapsible form assembly of claim 13 further comprising covers over an inside of each of said collapsible corner assemblies.

22. A collapsible form assembly for use in forming a structure from a moldable material, said collapsible form assembly comprising:
at least first and second collapsible corner assemblies for positioning at opposite corners, wherein each of said collapsible corner assemblies include collapsible side portions and retractable members forming outer corner forming surfaces, and wherein said retractable members retract and said collapsible side portions move inwardly to shrink said outer corner forming surfaces;
at least first and second fixed corner assemblies for positioning at opposite corners; and
intermediate panels secured between said collapsible corner assemblies and respective said fixed corner assemblies.
